(19) United States
(12) Patent Application Publication
(10) Pub. No.: US 2016/0379219 A1
(43) Pub. Date: Dec. 29, 2016

(54) SETTLEMENT APPARATUS

(71) Applicant: TOSHIBA TEC KABUSHIKI KAISHA, Tokyo (JP)

(72) Inventor: Norimasa ARIGA, Izunokuni Shizuoka (JP)

(21) Appl. No.: 14/750,883

(22) Filed: Jun. 25, 2015

(51) Int. Cl. G06Q 20/40

(52) U.S. Cl. CPC G06Q 20/40145

(57) ABSTRACT

According to one embodiment, a settlement apparatus includes a commodity detection unit, a personal authentication unit, and a settlement unit. The commodity detection unit detects commodities to be settled. The personal authentication unit executes first personal authentication on a settler who settles a purchase price of the commodities which the commodity detection unit detects, and further executes second personal authentication if the commodities which the commodity detection unit detects meet a predetermined condition. The settlement unit settles the purchase price of the commodities which the commodity detection unit detected, if the personal authentication by the personal authentication unit was successfully carried out.

### FIELD

Embodiments described herein relate generally to a settlement apparatus.

### BACKGROUND

A settlement apparatus executes a commodity registration process and a settlement process. For the purpose of reduction in cost, etc., settlement apparatuses, which require no human intervention, are developed by automation of processes. In order to shorten a checkout time, the settlement apparatus is required to efficiently execute the commodity registration process and settlement process. In the settlement apparatus, if erroneous recognition occurs in personal authentication in the settlement process, a loss or compensation increases as the settlement amount becomes higher. However, in the settlement apparatus, as the personal authentication in the settlement process is made stricter, a longer time is needed for the settlement process. For example, in biometrics authentication such as facial authentication, if a threshold for authentication is set to be higher, the precision of authentication can be made higher. In this case, however, since the false rejection rate increases, the time for the authentication process becomes longer. There is a demand for the settlement apparatus to shorten the checkout time while securing a necessary authentication precision.

### BRIEF DESCRIPTION OF THE DRAWINGS

FIG. 1 is a schematic view which schematically illustrates an external-appearance configuration example of a settlement apparatus according to a first embodiment.

FIG. 2 is a view illustrating a configuration example of the settlement apparatus according to the first embodiment.

FIG. 3 is a view illustrating a configuration example of the settlement apparatus according to the first embodiment.

FIG. 4 is a block diagram illustrating a configuration example of a control system of the settlement apparatus according to the first embodiment.

FIG. 5 is a view illustrating a configuration example of a commodity database.

FIG. 6 is a view illustrating a configuration example of a commodity price list.

FIG. 7 is a view illustrating a configuration example of a personal information database.

FIG. 8 is a view illustrating a configuration example of a setting file.

FIG. 9 is a flowchart illustrating the flow of the entirety of a checkout process in the settlement apparatus according to the first embodiment.

FIG. 10 is a flowchart for describing a commodity detection process in the settlement apparatus according to the first embodiment.

FIG. 11 is a flowchart for describing the flow of a personal authentication process in the settlement apparatus according to the first embodiment.

FIG. 12 is a flowchart for describing the flow of a settlement process in the settlement apparatus according to the first embodiment.

FIG. 13 is a flowchart for describing a data edit process in the settlement apparatus according to the first embodiment.

FIG. 14 is a schematic view illustrating an external-appearance configuration example of a settlement apparatus according to a second embodiment.

FIG. 15 is a view illustrating a configuration example of the settlement apparatus according to the second embodiment.

FIG. 16 is a view illustrating a configuration example of the settlement apparatus according to the second embodiment.

FIG. 17 is a block diagram illustrating a configuration example of a control system of the settlement apparatus according to the second embodiment.

FIG. 18 is a flowchart for describing a commodity detection process in the settlement apparatus according to the second embodiment.

FIG. 19 is a flowchart for describing the flow of a personal authentication process in the settlement apparatus according to the second embodiment.

FIG. 20 is a flowchart for describing a personal authentication process in a settlement apparatus according to a third embodiment.

### DETAILED DESCRIPTION

In general, according to one embodiment, a settlement apparatus includes a commodity detection unit, a personal authentication unit, and a settlement unit. The commodity detection unit detects commodities to be settled. The personal authentication unit executes first personal authentication on a settler who settles a purchase price of the commodities which the commodity detection unit detects, and further executes second personal authentication if the commodities which the commodity detection unit detects meet a predetermined condition. The settlement unit settles the purchase price of the commodities which the commodity detection unit detected, if the personal authentication by the personal authentication unit was successfully carried out.

Various embodiments will be described hereinafter with reference to the accompanying drawings.

### First Embodiment

To begin with, a settlement apparatus 1A according to a first embodiment is described.

FIG. 1 is a schematic view illustrating an external-appearance configuration example of the settlement apparatus 1A.

The settlement apparatus 1A recognizes commodities which are objects of settlement, and settles the purchase price of the recognized commodities. The settlement apparatus 1A is disposed, for example, in a store which sells goods. The settlement apparatus 1A is installed as a self-checkout system which a user operates by himself/herself. In addition, the settlement apparatus 1A may be an ordinary cash register which a salesclerk of the store operates.

As illustrated in FIG. 1, the settlement apparatus 1A includes a table 11, a first camera 12 and a second camera 13. The settlement apparatus 1A settles for commodities in a basket 2 placed on the table 11, as commodities that are objects of settlement. Incidentally, the settlement apparatus 1A may be configured to settle for commodities which are directly disposed on the table 11.

The first camera 12 is a camera for photographing commodities which are objects of settlement (recognition). The first camera 12 is disposed above the table 11. The first camera 12 photographs, from above the table 11, a photography range including the top side of the table 11. The first camera 12 photographs commodities in the basket 2 placed on the table 11. For example, the first camera 12 is composed of a CCD camera or the like. In addition, the first camera 12 may be a camera which captures images of commodities with invisible light. The first camera 12 may be a plurality of cameras. The structure of the first camera 12 is not limited to a specific structure.

The second camera 13 is a camera for photographing the face of a user (“settler”) who executes settlement. The second camera 13 is disposed at such a position as to be able to photograph the face of the settler. The second camera 13 is disposed to face the user standing in front of the table 11, so that the second camera 13 can easily photograph the face of the user who places the basket 2 on the table 11. The second camera 13 captures a face image (biometric characteristic) as authentication information of a person who is the object of personal authentication. For example, the second camera 13 is composed of a CCD camera or the like. The second camera 13 may be any camera if the second camera 13 can capture an image which enables detection of characteristic points of the face, and may be a camera which photographs the face of a person with invisible light. In addition, the second camera 13 may be a plurality of cameras. The structure of the second camera 13 is not limited to a specific structure.

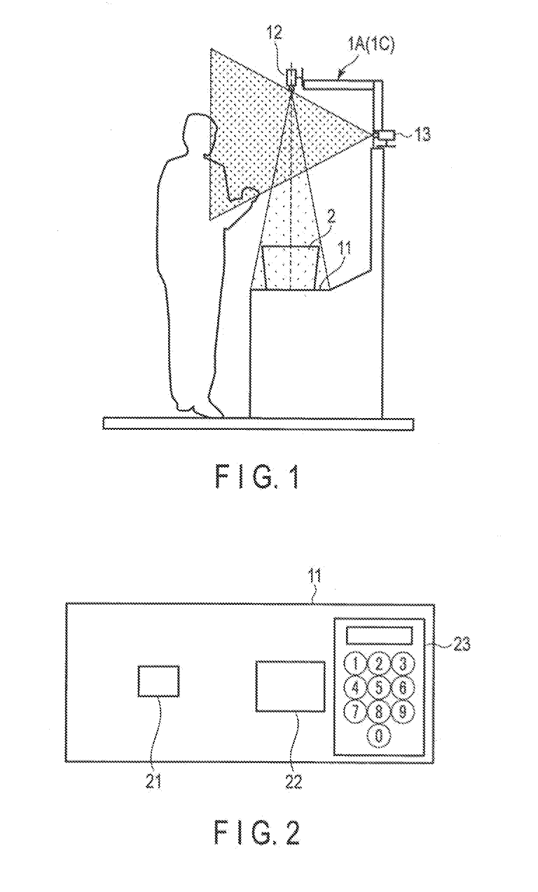

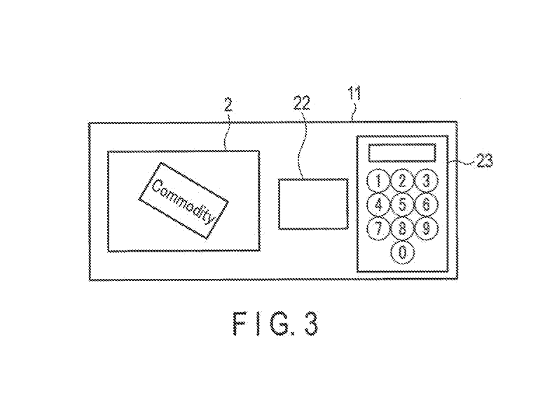

FIG. 2 and FIG. 3 are views illustrating configuration examples of a top side of the table 11 of the settlement apparatus 1A.

As illustrated in FIG. 2, a basket sensor 21, a display 22 and input keys 23 are provided on the table 11 of the settlement apparatus 1A.

The basket sensor 21 detects the basket 2. The basket sensor 21 is provided at a position on the table 11, where the basket 2 is placed. Specifically, the basket sensor 21 detects that the basket 2 was placed on the table 11. As illustrated in FIG. 3, it is assumed that the basket 2 is placed at a position including a position of disposition of the basket sensor 21 on the table 11.

The display 22 displays guidance, etc. to the user. The display 22 is, for instance, a liquid crystal display. The display 22 is disposed on the table 11. It should suffice if the display 22 is disposed at such a position that the user can view display content, and the position of disposition of the display 22 is not limited to a specific position. For example, the display 22 may be disposed near the second camera 13, so that the second camera 13 may easily photograph the face of the user.

The input keys 23 are buttons through which the user inputs instructions. The input keys 23 are, for instance, numeral keys. The input keys 23 may be a touch panel-equipped display. The input keys 23 are disposed on the table 11. The position of disposition of the input keys 23 is not limited to a specific position. For example, input keys 23 may be disposed near the second camera 13.

Next, a configuration example of a control system of the settlement apparatus 1A is described.

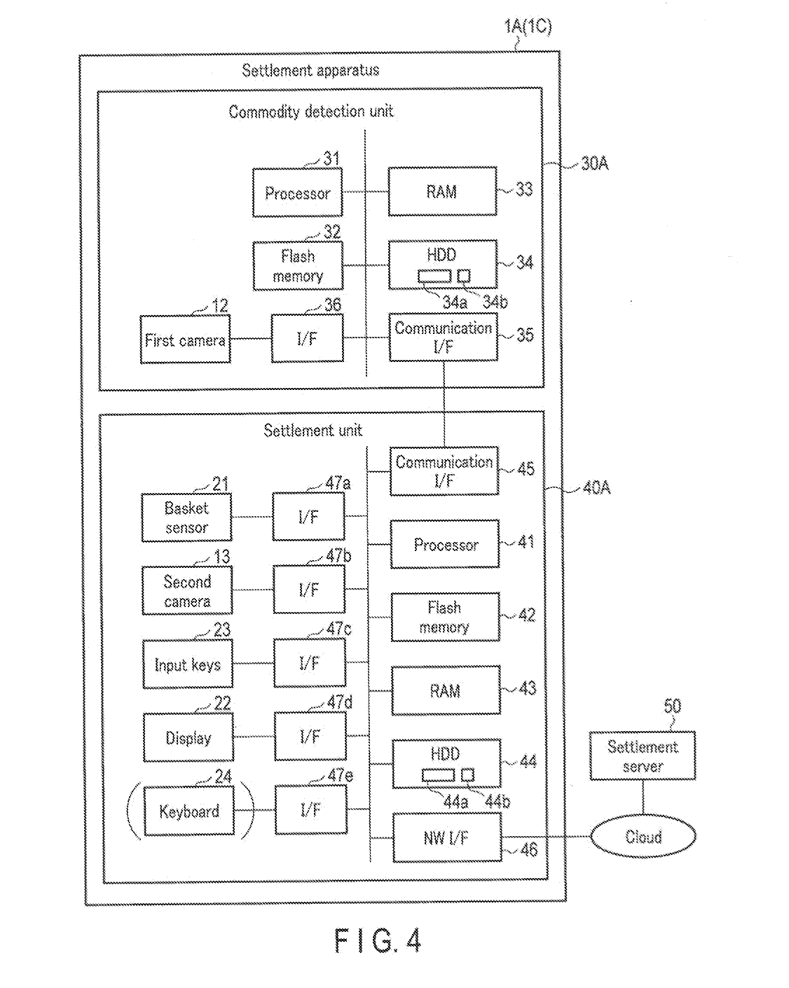

FIG. 4 is a block diagram illustrating a configuration example of the control system of the settlement apparatus 1A.

In the configuration example illustrated in FIG. 4, the settlement apparatus 1A includes a commodity detection unit 30A and a settlement unit 40A. For example, the settlement apparatus 1A operates, with the settlement unit 40A functioning as a master, and with the commodity detection unit 30A functioning as a slave. The commodity detection unit 30A executes a commodity detection process of detecting commodities that are objects of settlement. The commodity detection unit 30A detects identification patterns (e.g. bar codes) which identify commodities from a photographed image, and recognizes (detects) the commodities by the detected identification patterns. The settlement unit 40A executes a settlement process for the commodities which the commodity detection unit 30A detected. For example, the commodity detection unit 30A detects commodities, and creates a list (commodity price list) which associates the detected commodities and the prices of the respective commodities. The settlement unit 40A executes settlement for the commodity price list which the commodity detection unit 30A created.

In the configuration example illustrated in FIG. 4, the commodity detection unit 30A includes a processor 31, a flash memory 32, a RAM 33, an HDD 34, a communication I/F 35, and an I/F 36. The processor 31, flash memory 32, RAM 33, HDD 34, communication I/F 35 and I/F 36 are connected via a bus.

The processor 31 is, for example, a CPU. The processor 31 realizes various processes, based on programs and control data which the flash memory 32 or HDD 34 stores. For example, the processor 31 executes the commodity detection process by executing programs which the flash memory 32 stores. Incidentally, a part of various functions which the processor 31 realizes, as will be described later, may be realized by hardware.

The flash memory 32 is a nonvolatile memory which prestores programs for control, and control data. The flash memory 32 stores programs and control data for the commodity detection unit 30A of the settlement apparatus 1A to execute commodity detection. For example, the flash memory 32 stores a program for detecting identification patterns of the respective commodities from an image which the first camera 12 captures, and recognizing the commodities by the detected identification patterns.

The RAM 33 is a volatile memory. The RAM 33 functions as a working memory. The RAM 33 temporarily stores data which the processor 31 is processing. For example, the RAM 33 temporarily stores application programs, based on instructions from the processor 31. In addition, the RAM 33 may store image data, and may store execution results of the application programs.

The HDD 34 is a nonvolatile memory which is capable of data write and data rewrite. For example, the HDD 34 stores control programs, applications, and various data, which correspond to operational purposes of the settlement apparatus 1A. In addition, the HDD 34 stores various databases. For example, the HDD 34 includes a commodity database (DB) 34a which stores information (commodity information) relating to commodities which are objects of recognition. The HDD 34 also includes a commodity price list 34b as a result of the commodity detection process. Incidentally, the commodity DB 34a or commodity price list 34b may be provided in a server which is communicable via a communication interface.

The communication I/F 35 is an interface for communication with the settlement unit 40. The I/F 36 is an interface for connection to the first camera 12. The I/F 36 functions as an image acquisition unit which acquires an image which the first camera 12 captured as an object of the recognition process. For example, the processor 31 instructs the first camera 12 to capture an image, via the I/F 36 functioning as a camera interface, and acquires the image which the first camera 12 captured.

In the configuration example illustrated in FIG. 4, the settlement unit 40A includes a processor 41, a flash memory 42, a RAM 43, an HDD 44, a communication I/F 45, a network (NW) I/F 46, and a plurality of I/Fs 47 (47a to 47e). The processor 41, flash memory 42, RAM 43, HDD 44, communication I/F 45, network (NW) I/F 46 and I/Fs 47a to 47e are connected via a bus.

The processor 41 is, for example, a CPU. The processor 41 realizes various processes, based on programs and control data which the flash memory 42 or HDD 44 stores. For example, the processor 41 executes the settlement process including a personal authentication process by executing the programs which the flash memory 42 stores. The settlement unit 40A executes two personal authentications in the settlement process. The processor 41 of the settlement unit 40A illustrated in FIG. 4 executes facial authentication as a first personal authentication, and executes password authentication as a second personal authentication.

However, the second personal authentication is not limited to the password authentication. The second personal authentication may be replaced with personal authentication other than the password authentication. In addition, the first personal authentication is not limited to the facial authentication, and may be replaced with personal authentication other than the facial authentication. It should be noted, however, that the settlement unit 40A illustrated in FIG. 4 can facilitate the input of authentication information by the user, by executing facial authentication as the first personal authentication. Furthermore, the settlement unit 40A illustrated in FIG. 4 can realize reliable authentication which is hardly affected by an environmental change, etc., by executing password authentication as the second personal authentication.

The flash memory 42 is a nonvolatile memory which prestores programs for control, and control data. The flash memory 42 stores programs and control data for the settlement unit 40A of the settlement apparatus 1A to execute the settlement process including the personal authentication process. The flash memory 42 or HDD 44 stores programs for the first settlement process using the first personal authentication and second personal authentication. In addition, the flash memory 42 or HDD 44 stores a program for executing the first personal authentication, and a program for executing the second personal authentication. Incidentally, a part of various functions which the processor 41 realizes by executing programs, as will be described later, may be realized by hardware.

The RAM 43 is a volatile memory. The RAM 43 functions as a working memory. The RAM 43 temporarily stores data which the processor 41 is processing. For example, the RAM 43 temporarily stores application programs, based on instructions from the processor 41. In addition, the RAM 43 may store image data, and may store execution results of the application programs.

The HDD 44 is a nonvolatile memory which is capable of data write and data rewrite. For example, the HDD 44 stores application programs, and various data. In addition, the HDD 44 stores various databases. For example, the HDD 44 includes a personal information database (DB) 44a which stores personal information of each person (e.g. a member) who is the object of personal authentication. The HDD 44 also includes a setting file 44b which stores setting information in personal authentication (to be described later). Incidentally, the personal information DB 44a or setting file 44b may be provided in a server which is communicable via a communication interface.

The personal information DB 44a of the settlement unit 40A stores personal information including dictionary data for the first personal authentication and dictionary data for the second personal authentication. The dictionary data for the first personal authentication, which is stored in the personal information DB 44a of the settlement unit 40A shown in FIG. 4, is characteristic information of the face of a enrolled person for use in facial authentication. The dictionary data for the second personal authentication, which is stored in the personal information DB 44a of the settlement unit 40A shown in FIG. 4, is a password of the enrolled person for use in password authentication.

The communication I/F 45 is an interface for communication with the commodity detection unit 30. The network (NW) I/F 46 is an interface for communication with an external settlement server 50. For example, the network I/F 46 connects to the settlement server 50 via a cloud, etc. The settlement server 50 is an external server (e.g. a server of a settlement company) for settlement of purchase prices of commodities. The settlement server 50 is a server for settling purchase prices of commodities by using a credit card which the user presents.

The I/F 47a is an interface for connection to the basket sensor 21. The processor 41 acquires a signal from the basket sensor 21 via the I/F 47a.

The I/F 47b is an interface for connection to the second camera 13. The I/F 47b functions as an image acquisition unit which acquires an image (face image) including the face which the second camera 13 captures as an object of facial authentication. For example, the processor 41 instructs, via the I/F 47b, the second camera 13 to capture a face image, and acquires the image which the second camera 13 captured.

The I/F 47c is an interface for connection to the input keys 23. The processor 41 acquires, via the I/F 47c, information (signal) which was input to the input keys 23. For example, when the input keys 23 are a touch panel provided on the display screen of the display 22, the processor 41 acquires a signal indicative of a touch position on the display screen via the I/F 47c.

The I/F 47d is an interface for connection to the display 22. The processor 41 controls, via the I/F 47d, display content which the display 22 displays. For example, when the input keys 23 are the touch panel provided on the display screen of the display 22, the processor 41 causes the display 22 to display selectable keys, etc., via the I/F 47d.

The I/F 47e is an interface for connection to a keyboard. In the settlement apparatus 1A, the I/F 47e is configured such that the operator can attach/detach the keyboard. The processor 41 includes a function of detecting a keyboard, which was connected to the I/F 47e, at an arbitrary timing. After detecting the connection of the keyboard to the I/F 47e, the processor 41 acquires a signal which was input to the keyboard connected to the I/F 47e.

Next, various data are described.

To begin with, the commodity database 34a is described.

The HDD 34 includes the commodity DB 34a which stores information (commodity information) relating to respective commodities, which are the objects of recognition. The commodity DB 34a may be of any type, if the processor 31 of the commodity detection unit 30A can access the commodity DB 34a. For example, the commodity DB 34a may be provided in the HDD 44 of the settlement unit 40A. In addition, the commodity DB 34a may be provided in an external device (e.g. a server) which the settlement apparatus 1A can access.

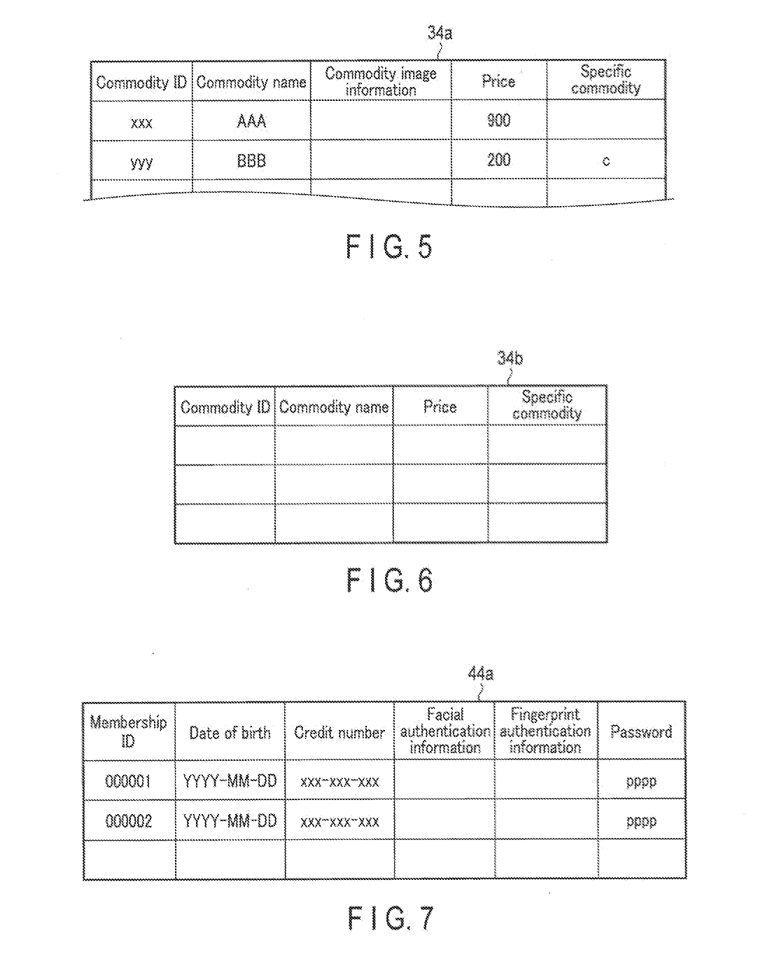

FIG. 5 is a view illustrating a configuration example of the commodity database 34a.

in the example illustrated in FIG. 5, the commodity DB 34a stores, as commodity information of each commodity, a commodity ID, a commodity name, commodity image information, a price, and a specific commodity flag. The commodity ID is commodity identification information for identifying the commodity. The commodity image information is an image of the commodity. The price is a price (purchase price) of the commodity. The specific commodity flag is information indicating whether the commodity is a specific commodity or not. The specific commodity is arbitrarily settable. For example, an administrator sets a specific commodity flag for a commodity that is set to be the specific commodity. The specific commodities are assumed to be, for instance, expensive commodities, commodities the number of which is limited, commodities with age limits, or commodities with membership privileges (members-only discount, advance sale, members-only sale).

For example, in the case of recognizing a commodity by a bar code which is added to the commodity, a bar code, in which information including the commodity ID is encoded, is added to the commodity. The commodity detection unit 30A searches for commodity information in the commodity DB 34a, by the commodity ID which is obtained by decoding the bar code. In addition, in the case of recognizing a commodity by an RFID which is added to the commodity, an RFID, in which information including the commodity ID is recorded, is added to the commodity. The commodity detection unit 30A searches for commodity information in the commodity DB 34a, by the commodity ID which is read from the RFID that is added to the commodity. Furthermore, in the case of recognizing a commodity by a pattern of the commodity itself, the commodity detection unit 30A identifies the commodity by collating the image captured by photographing the commodity and the commodity image information of the commodity DB 34a.

In the meantime, the configuration of the commodity DB 34a is not limited to the configuration illustrated in FIG. 5. The commodity DB 34a may be of any type, if the commodity DB 34a can determine the price of the commodity that is detected as the object of settlement. For example, in the case of not executing commodity detection by the commodity image, the commodity DB 34a may not store the commodity image information as commodity information. In addition, in the case of not executing a change of personal authentication (second personal authentication) corresponding to a specific commodity, the commodity DB 34a may not store the specific commodity flag as the commodity information of each commodity.

Next, the commodity price list 34b is described.

The commodity price list 34b shows a list of commodities which were detected as objects of settlement by the commodity detection process. The prices of the respective commodities, which are objects of settlement, are registered in the commodity price list 34b. The commodity detection unit 30A creates the commodity price list 34b. The commodity detection unit 30A stores the created commodity price list 34b in the HDD 34. The commodity price list 34b may be of any type, if the processor 41 of the settlement unit 40A can access the commodity price list 34b. For example, the HDD 44 of the settlement unit 40A may store the commodity price list 34b. Besides, an external device (e.g. a server), which the settlement apparatus 1A can access, may store the commodity price list 34b.

FIG. 6 is a view illustrating a configuration example of the commodity price list 34b.

In the example illustrated in FIG. 6, the commodity price list 34b lists up commodities that are objects of settlement. The commodity price list 34b stores a commodity ID, a commodity name, a price and a specific commodity flag with respect to each of the commodities that are the objects of settlement. The commodity ID is commodity identification information for identifying the commodity. The price is a price (purchase price) of the commodity. The specific commodity flag is information indicating whether the commodity is a specific commodity or not.

In the meantime, the configuration of the commodity price list 34b is not limited to the configuration illustrated in FIG. 6. The commodity price list 34b may be of any type, if the commodity price list 34b records at least the price of each commodity. For example, in the case of not executing a change of personal authentication by a specific commodity flag, the commodity price list 34b may not store the specific commodity flag.

Next, the personal information database 44a is described.

The personal information database (DB) 44a stores personal information of each person (an individual who is the object of personal authentication) who may become a settler. The person who is the object of personal authentication may be, for example, a member who is permitted to execute checkout by the settlement apparatus 1A. The personal information DB 44a stores personal information including information which is used for authentication of each individual. The personal information DB 44a may be of any type, if the processor 41 of the settlement unit 40A can access the personal information DB 44a. For example, the HDD 34 of the commodity detection unit 30A may store the personal information DB 44a. Besides, an external device (e.g. a server), which the settlement apparatus 1A can access, may store the personal information DB 44a.

FIG. 7 is a view illustrating a configuration example of the personal information DB 44a.

In the example illustrated in FIG. 7, the personal information DB 44a stores, on an individual-by-individual basis, personal information including a membership ID, date of birth, a credit number, facial authentication information, fingerprint authentication information, and a password. The membership ID is personal identification information for identifying an individual. The date of birth is personal information of the present person. The credit number is information relating to a credit card for use in settlement.

The facial authentication information is dictionary data for use in facial authentication. The facial authentication information is enrolled as characteristic information (landmark information) of the face of the present person. The fingerprint authentication information is dictionary data for use in fingerprint authentication. The fingerprint authentication information is enrolled as characteristic information of the fingerprint of the present person (or fingerprint image information). The facial authentication information and fingerprint authentication information are used for personal authentication (biometrics authentication) by the face and fingerprint as biometrics information. The password is dictionary data for password collation for use in password authentication. The password is information which the present person arbitrarily sets. The password is used for personal authentication by memory information which a to-be-authenticated person himself/herself memorizes.

In the meantime, in the configuration example of the settlement apparatus 1A according to the first embodiment, the settlement apparatus 1A uses the facial authentication information of the personal information DB 44a for the facial authentication as the first personal authentication. In addition, the settlement apparatus 1A uses the password of the personal information DB 44a for the password authentication as the second personal authentication. Besides, in a configuration example of a settlement apparatus 1B according to a second embodiment which will be described later, the settlement apparatus 1B uses the facial authentication information of the personal information DB 44a for the facial authentication as the first personal authentication, and uses the fingerprint authentication information of the personal information DB 44a for the fingerprint authentication as the second personal authentication.

Incidentally, the personal information, which the personal information DB 44a stores, is not limited to the personal information shown in FIG. 7. The personal information DB 44a records at least the authentication information for use in each personal authentication in the settlement process. For example, the settlement apparatus 1A executes facial authentication as the first personal authentication, and executes password authentication as the second personal authentication. Thus, the personal information DB 44a may not record the fingerprint authentication information of each individual.

Next, the setting file 44b is described.

The setting file 44b stores various setting information in the settlement process. The setting file 44b stores a threshold for use in the first personal authentication, and condition information for determining whether second personal information is necessary or not. The setting fil 44b is capable of editing (setting alteration) by a data edit process (to be described later). The setting file 44b is stored in the HDD 44. The setting file 44b is updated (e.g. overwritten and saved) when the setting file 44b was edited by the data edit process. The setting file 44b may be of any type, if the processor 41 of the settlement unit 40A can access the setting file 44b. For example, the HDD 34 of the commodity detection unit 30A may store the setting file 44b. Besides, an external device (e.g. a server), which the settlement apparatus 1A can access, may store the setting file 44b.

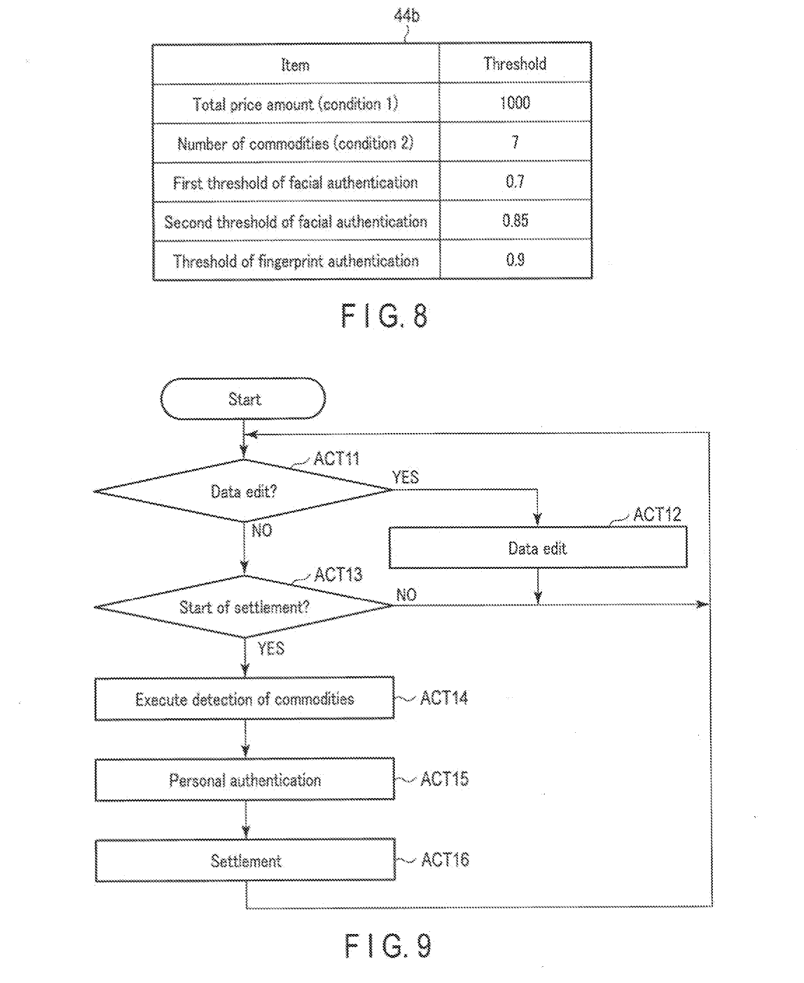

FIG. 8 is a view illustrating a configuration example of the setting file 44b.

In the example illustrated in FIG. 8, the setting file 44b stores a total price amount, the number of commodities, a first threshold of facial authentication, a second threshold of facial authentication, and a threshold of fingerprint authentication. The total price amount is a condition (first determination condition) for determining whether the second personal authentication is necessary or not. The number of commodities is a condition (second determination condition) for determining whether the second personal authentication is necessary or not. Incidentally, it should suffice if the setting file 44b of the settlement apparatus 1A sets any one of the conditions. In addition, it should suffice if a setting file of a settling apparatus 1B (to be described later) sets any one of the conditions.

The first threshold of facial authentication and the second threshold of facial authentication are thresholds for determining the identity of an individual in facial authentication. The threshold of fingerprint authentication is a threshold for determining the identity of an individual in fingerprint authentication. These thresholds for authentication are set in accordance with the personal authentication which is executed in the settlement. For example, the settlement apparatus 1A sets one threshold for facial authentication in the setting file 44b. In addition, the settlement apparatus 1B according to the second embodiment (to be described later) sets one threshold for facial authentication and one threshold for fingerprint authentication in the setting file 44b. Besides, a settlement apparatus 1C according to a third embodiment (to be described later) sets a first threshold and a second threshold, which is greater than the first threshold, for facial authentication in the setting file 44b.

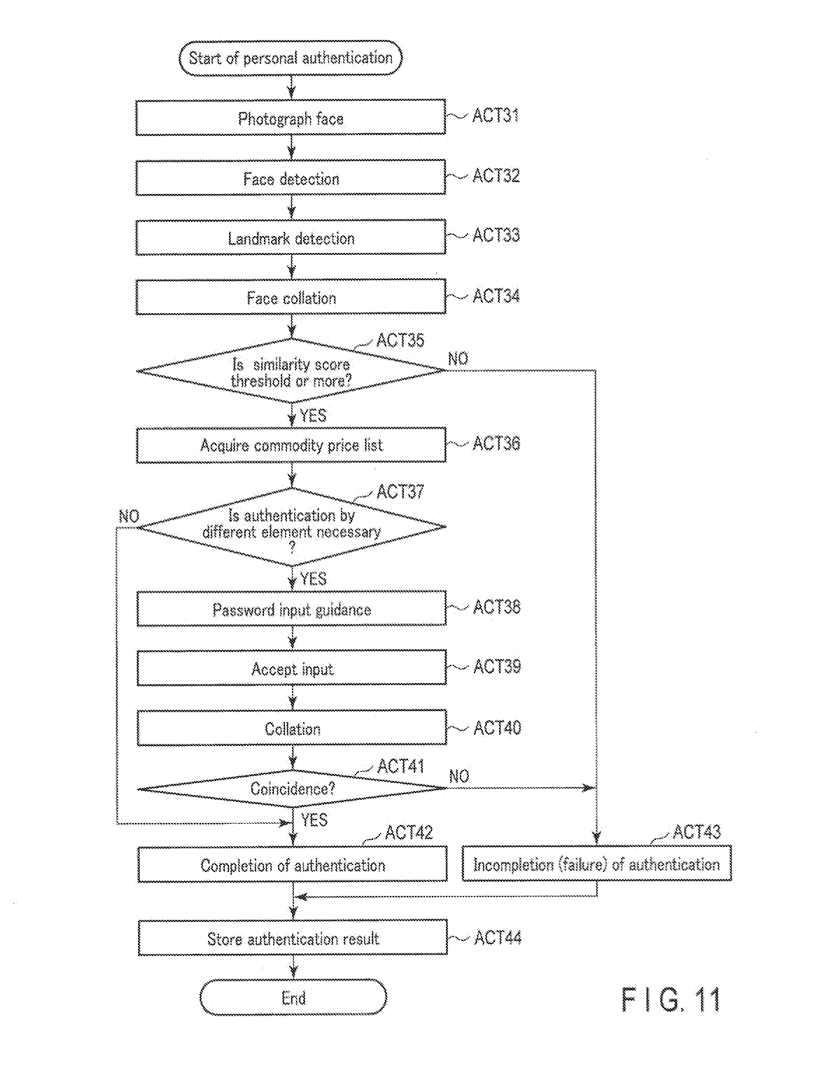

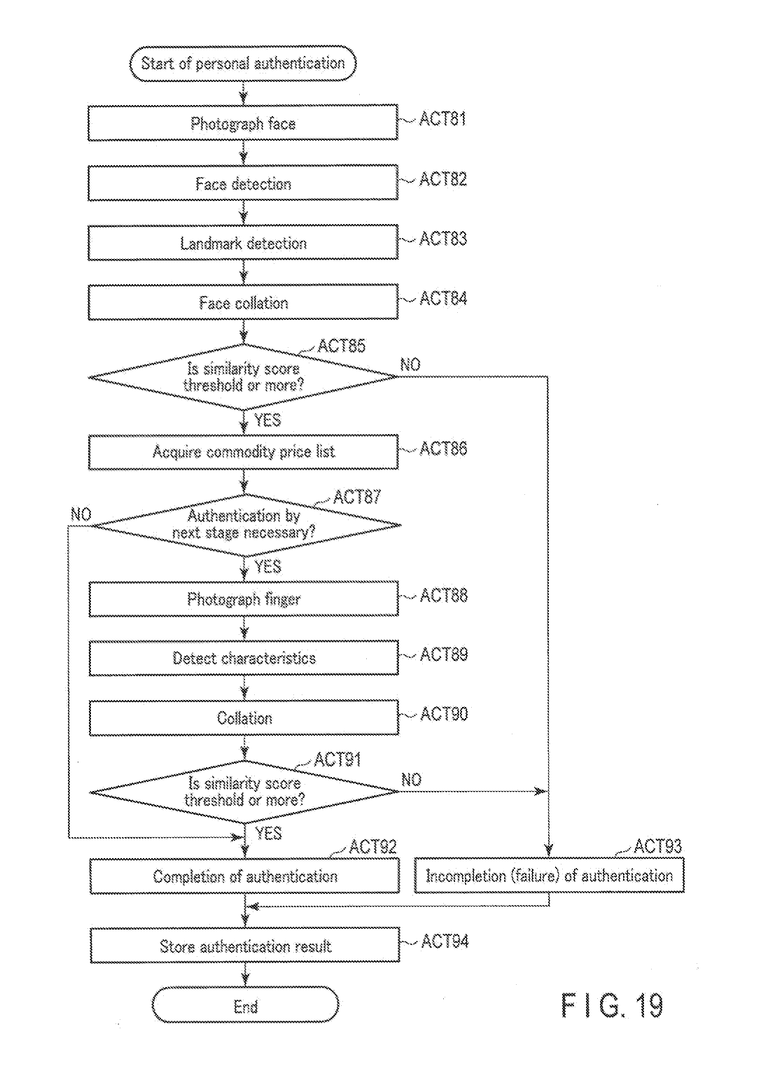

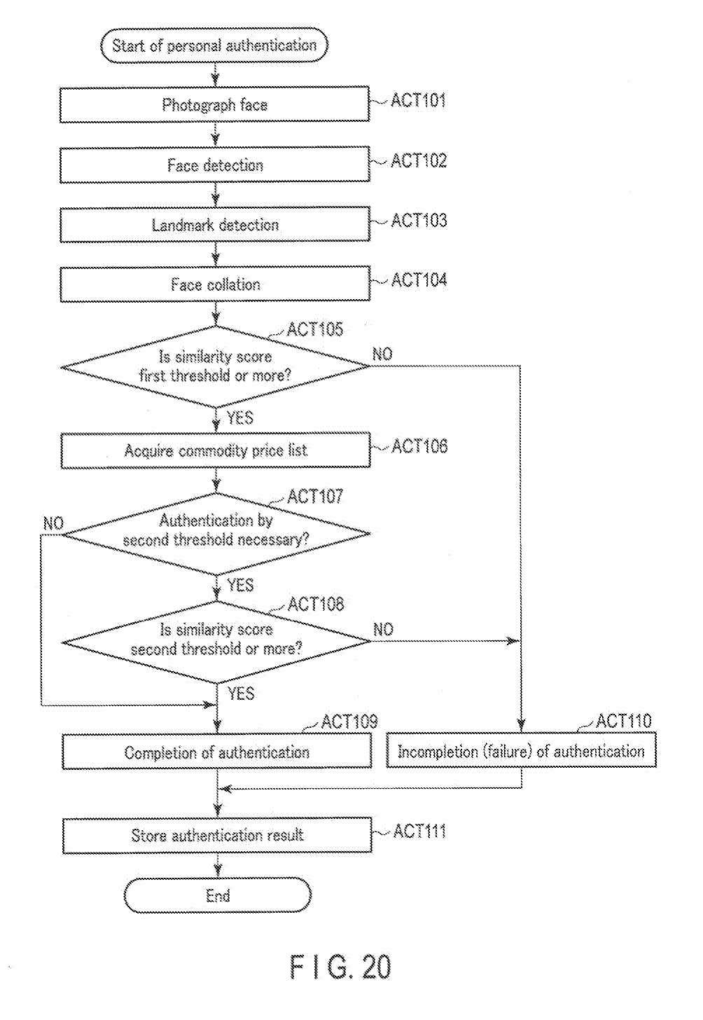

Incidentally, the setting information, which the setting file 44b stores, is not limited to the setting information illustrated in FIG. 8. It should suffice if the setting information, which the setting file 44b stores, is setting information which is set in accordance with the personal authentication that is executed. For example, the settlement apparatus 1A, which executes personal authentication illustrated in FIG. 11 (to be described later), may set one determination condition and one threshold for facial authentication. In addition, the settlement apparatus 1B, which executes personal authentication illustrated in FIG. 19 (to be described later), may set one determination condition, a threshold for facial authentication and a threshold for fingerprint authentication. Besides, the settlement apparatus 1C, which executes personal authentication illustrated in FIG. 20 (to be described later), may set a first threshold for facial authentication and a second threshold for facial authentication.

Next, a description is given of a checkout process in the settlement apparatus 1A according to the first embodiment.

FIG. 9 is a flowchart illustrating the flow of the entirety of a checkout process in the settlement apparatus 1A.

The settlement apparatus 1A accepts data edit or a start of settlement in a standby state. For example, the settlement apparatus 1A starts data edit when the keyboard was connected to the I/F 47e. In addition, the settlement apparatus 1A starts settlement (checkout) of commodities when the basket 2 was placed on the table 11.

Specifically, the processor 41 of the settlement unit 40A, which comprehensively controls the settlement apparatus 1A, accepts data edit by a predetermined operation in the standby state (ACT 11). The data edit is a process of editing, for example, the threshold that is used for authentication such as facial authentication. In the standby state, the processor 41 checks whether the keyboard was connected to the I/F 47e.

If the processor 41 detects that the keyboard was connected to the I/F 47e (ACT 11, YES), the processor 41 starts the process of data edit (ACT 12). The process of data edit will be described later in detail.

If there is no request for the start of data edit (if the keyboard is not connected to the I/F 47e) (ACT 11, NO), the processor 41 determines whether or not to start settlement (ACT 13). For example, the processor 41 determines the start of settlement, when the basket sensor 21 detected that the basket 2 was placed on the table 11.

If the basket sensor 21 detects the basket 2 (ACT 13, YES), the processor 41 causes the commodity detection unit 30A to execute the commodity detection process (ACT 14). The processor 41 sends a request for starting the commodity detection process to the commodity detection unit 30A via the communication I/F 45. The processor 31 of the commodity detection unit 30A receives the request for starting the commodity detection process via the communication I/F 35. Upon receiving the request for starting the commodity detection process, the processor 31 executes the commodity detection process. The commodity detection process will be described later in detail.

In addition to sending the request for starting the commodity detection process to the commodity detection unit 30A, the processor 41 executes a personal authentication process for authenticating the settler (ACT 15). For example, the processor 41 of the settlement apparatus 1A starts the personal authentication process in parallel with the commodity detection process by the commodity detection unit 30A. Alternatively, the processor 41 of the settlement apparatus 1A may execute the personal authentication process after the end of the commodity detection process. The personal authentication process in the settlement apparatus 1A will be described later in detail.

Upon completion of the personal authentication process, the processor 41 executes settlement of purchase prices of commodities (ACT 16). If the personal authentication failed in the personal authentication process, the processor 41 causes the display 22 to display a notification that the settlement of commodities is incomplete, and terminates the series of processes. If the personal authentication was successful in the personal authentication process, the processor 41 acquires a commodity price list as a result of the commodity detection process. Upon acquiring the commodity price list, the processor 41 settles the payment of the settlement amount based on the commodity price list. If the settlement process normally ends, the processor 41 causes the display 22 to display a notification of the normal end of settlement, and terminates the series of processes.

Next the commodity detection process in the settlement apparatus 1A is described.

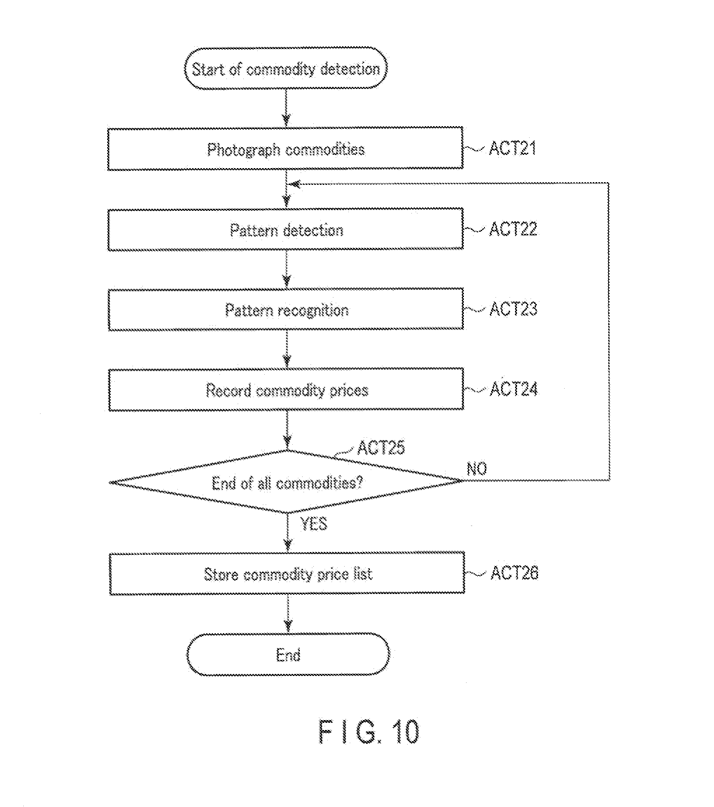

FIG. 10 is a flowchart for describing the commodity detection process in the settlement apparatus 1A.

Responding to the request for starting the commodity detection process from the settlement unit 40A, the processor 31 of the commodity detection unit 30A starts the commodity detection process. To start with, the processor 31 photographs an image of commodities by the first camera 12 (ACT 21). The processor 31 instructs the first camera 12 to start photography via the I/F 36. In accordance with the instruction from the processor 31, the first camera 12 captures an image of a predetermined photography range. The photography range includes at least a region on the table 11, where the basket 2 is placed (or a region where commodities are directly placed). The first camera 12 outputs the photographed image (commodity image) to the I/F 36. The processor 31 acquires, via the I/F 36, the photographed image which the first camera 12 captured. Upon acquiring the photographed image of the first camera 12, the processor 31 temporarily stores the photographed image in the RAM 33.

Upon storing the photographed image, the processor 31 detects an identification pattern for identifying each commodity from the photographed image (ACT 22). Upon detecting the identification pattern from the photographed image, the processor 31 executes commodity recognition on each detected identification pattern (ACT 23). For example, the processor 31 detects bar codes as identification patterns for identifying commodities. Upon detecting the bar codes as identification patterns, the processor 31 decodes the detected bar codes, and determines commodity identification information (commodity ID) included in the decoded information.

By searching the commodity DB 34a based on the determined commodity identification information, the processor 31 acquires the commodity information of the commodities. The processor 31 creates, on the RAM 33, a commodity price list as a result of the commodity detection process. The processor 31 additionally writes commodity information of each commodity, which is acquired by the commodity recognition, to the commodity price list (ACT 24). For example, the commodity price list registers commodity information, such as a commodity ID, a commodity name, a commodity price, and information indicative of a specific commodity or not.

The processor 31 determines whether the recognition of all commodities (identification patterns) in the photographed image was completed (ACT 25). If the processor 31 determines that the recognition of all commodities in the photographed image is yet to be completed (ACT 25, NO), the processor 31 repeatedly executes the above process of ACT 22 to ACT 24. If the processor 31 determines that the recognition of all commodities in the photographed image was completed (ACT 25, YES), the processor 31 stores the created commodity price list as a file (commodity price list file) in a predetermined folder in the HDD 34 (ACT 26). Upon storing the commodity price list in the HDD 34, the processor 31 notifies the processor 41 of the settlement unit 40A of the end of the commodity detection process.

Incidentally, the above-described commodity detection process is merely an example, and the commodity detection process may be any process if a commodity registration list can be obtained as a result of the commodity detection process. For example, the commodity detection unit 30A is not limited to a commodity detection unit for bar code recognition, and may be a commodity detection unit for pattern recognition, object recognition, or OCR. In addition, the commodity detection unit 30A may be configured to recognize a commodity by an RFID that is attached to the commodity, as in a settlement apparatus 1B which will be described later.

Next, the personal authentication process in the settlement apparatus 1A is described.

FIG. 11 is a flowchart for describing the flow of the personal authentication process in the settlement apparatus 1A.

Upon starting the personal authentication process, the processor 41 of the settlement apparatus 1A captures, by the second camera 13, an image including the face of the user (ACT 31). The processor 41 instructs, via the I/F 47b, the second camera 13 to start photography. In accordance with an instruction from the processor 41, the second camera 13 captures an image of a predetermined photography range. The second camera 13 outputs the captured image (face image) to the I/F 47b. The processor 41 acquires, via the I/F 47b, the photographed image which the second camera 13 captured. Upon acquiring the photographed image of the second camera 13, the processor 31 temporarily stores the photographed image in the RAM 43.

Upon storing the photographed image of the second camera 13, the processor 41 detects a face region of the person in the photographed image (ACT 32). Upon detecting the face region, the processor 41 detects a predetermined characteristic point (landmark) from the image of the detected face region (ACT 33). The processor 41 temporarily stores information indicative of the detected characteristic point of the face in the RAM 43. Incidentally, the processor 41 may, if within a predetermined time, repeat photography until successfully detecting the characteristic point of the face from the image which the second camera 13 captures.

For example, the processor 41 detects, as the landmark, a predetermined part such as the outer corner of the eye, the inner corner of the eye, the nose, the mouth, etc. The processor 41 temporarily stores in the RAM 43 information (landmark information) indicative of a relative position of the detected landmark. The processor 41 determines the similarity score by collating the information detected from the photographed image and the characteristic information (dictionary data) of the enrolled person who is already enrolled in the personal information DB (ACT 34). For example, the processor 41 determines the similarity score (the similarity score of the face) between the landmark information (characteristic information of the face), which was detected from the photographed image, and the landmark information (dictionary data for facial authentication) of each enrolled person enrolled in the personal information DB.

Upon determining the similarity score of the face to each enrolled person, the processor 41 determines whether the highest similarity score of similarity score of the face is a threshold for facial authentication or more (ACT 35). The threshold for facial authentication is a reference value of the similarity score for determining the identity of the person in the facial authentication. Specifically, when the similarity score is the threshold or more, the processor 41 determines the identity of the person in the facial authentication as the first personal authentication. Incidentally, it is assumed that the threshold for facial authentication is settable by the data edit process.

If the processor 41 determines that the similarity score of the face is not the threshold for facial authentication or more (ACT 35, NO), the processor 41 determines that the personal authentication failed (ACT 43). Upon determining that the personal authentication failed, the processor 41 stores in the HDD 34 an authentication result indicating that the personal authentication failed (ACT 44).

If the processor 41 determines that the similarity score of the face is the threshold for facial authentication or more (ACT 35, YES), the processor 41 acquires the commodity price list that was obtained by the commodity detection process (ACT 36). For example, the commodity detection unit 30A stores in the HDD 34 the commodity price list that was obtained by the commodity detection process. The processor 41 acquires the commodity price list from the HDD 34 of the commodity detection unit 30A. In the meantime, in the case of executing the personal authentication and commodity detection in parallel, the processor 41 executes the process of ACT 35 after the end of the commodity detection process.

Upon acquiring the commodity price list, the processor 41 determines whether personal authentication by another factor is necessary or not (ACT 37). The settlement apparatus 1A includes a function of password authentication as second personal authentication by a factor different from the factor of the facial authentication as the first personal authentication. The processor 41 determines whether the personal authentication by the password authentication is necessary or not.

In addition, the processor 41 determines whether the personal authentication by the other factor is necessary or not, according to whether a predetermined condition is satisfied or not. The condition for determining whether the personal authentication by the other factor is necessary or not is set for, for example, the content of commodities to be settled. An example of a first condition is set as a threshold for a settlement amount (payment amount). In addition, an example of a second condition is set as a threshold for the number of commodities to be settled. Besides, an example of a third condition is set as a specific commodity. Furthermore, the condition for determining whether the personal authentication by the other factor is necessary or not may be a combination of a plurality of conditions.

Here, it is assumed that the threshold for the settlement amount is set as the condition for determining whether the personal authentication by the other factor is necessary or not. When the threshold for the settlement amount is set, the processor 41 determines whether the total price amount of commodities of the acquired commodity price list is a threshold or more (ACT 37). If the processor 41 determines that the total price amount of commodities is not the threshold or more (ACT 37, NO), the processor 41 determines that the personal authentication was completed (ACT 42). Upon determining that the personal authentication was completed, the processor 41 stores a personal authentication result indicating that the personal authentication was completed (ACT 44).

In addition, if the processor 41 determines that the total price amount of commodities is the threshold or more (ACT 37, YES), the processor 41 executes the password authentication as the personal authentication by the factor different from the factor of the facial authentication. Specifically, the processor 41 causes the display 22 to display input guidance of the password (ACT 38). After displaying the password input guidance on the display 22, the processor 41 accepts an input of the password by the input keys 23 (ACT 39). If the password is input to the input keys 23, the processor 41 collates the input password and the password of the enrolled person which was identified by the facial authentication (ACT 40).

If the processor 41 determines that the passwords coincide (ACT 41, YES), the processor 41 determines that the personal authentication is completed (ACT 42). Upon determining that the personal authentication is completed, the processor 41 stores a personal authentication result indicating the completion of the personal authentication (ACT 44).

In addition, if the processor 41 determines that the passwords do not coincide (ACT 41, NO), the processor 41 determines that the personal authentication is incomplete (failed) (ACT 43). Upon determining that the personal authentication failed, the processor 41 stores a personal authentication result indicating the incompletion of the personal authentication (ACT 44).

Incidentally, the personal authentication process in the settlement apparatus 1A is not limited to the above-described example. The personal authentication process in the settlement apparatus 1A may be any process if the personal authentication process executes a plurality of personal authentications by different factors. For example, the personal authentications by different factors may be personal authentication by biometric characteristics (face, iris, vein pattern, voiceprint, etc.), personal authentication by belongings (ID card, membership card, key, etc.), and personal authentication by memory information (password, etc.). Any two of these personal authentications by different factors can be adopted as the first personal authentication and second personal authentication.

For example, in the personal authentication process, the first personal authentication may be authentication by biometric characteristics, and the second personal authentication may be authentication by belongings. In addition, in the personal authentication process, the first personal authentication may be authentication by memory information, and the second personal authentication may be authentication by biometric characteristics. Furthermore, in the personal authentication process, three or more personal authentications may be combined and executed in accordance with a plurality of conditions. For example, in the personal authentication process, authentication by belongings may be executed as third personal authentication, in addition to the authentication by biometric characteristics and the authentication by memory information.

Next, the settlement process in the settlement apparatus 1A is described.

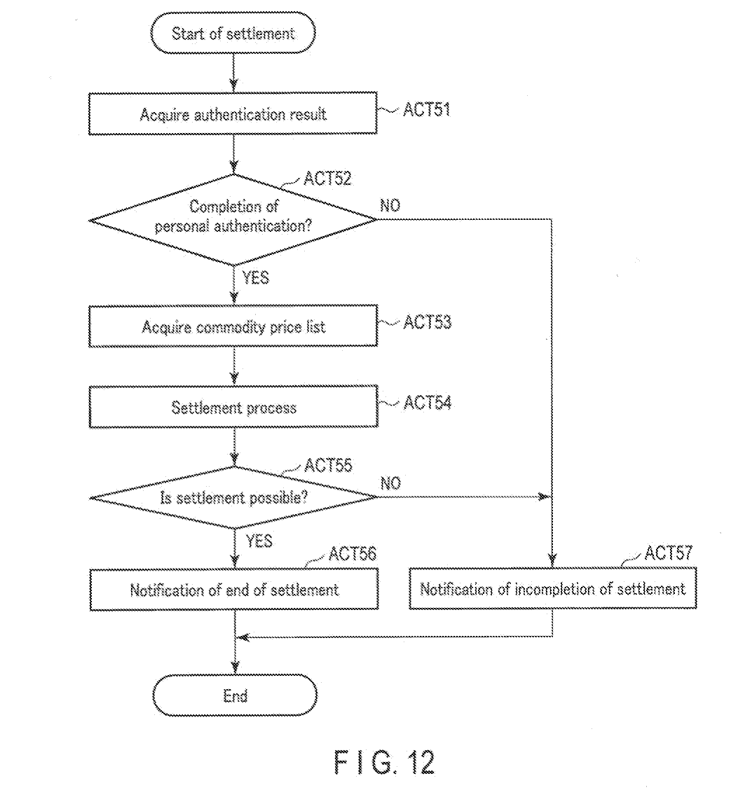

FIG. 12 is a flowchart for describing the flow of the settlement process in the settlement apparatus 1A.

If the personal authentication ends, the processor 41 of the settlement unit 40A starts settlement of payment of commodity purchase prices. To start with, the processor 41 acquires an authentication result file indicative of the personal authentication result (ACT 51). Upon acquiring the authentication result file, the processor 41 determines, by the authentication result file, whether the personal authentication was completed or not (ACT 52).

If the processor 41 determines that the personal authentication was completed (ACT 52, YES), the processor 41 acquires a commodity price list indicative of the processing result of the commodity detection by the commodity detection unit 30A (ACT 53). Upon acquiring the commodity price list, the processor 41 executes a settlement process based on the acquired commodity price list (ACT 54).

For example, the processor 41 reads in the file of the commodity price list from the HDD 34. Upon acquiring the commodity price list, the processor 41 calculates the total amount of the prices of all commodities that are objects of settlement, from the acquired commodity price list. Upon calculating the total price amount (settlement amount), the processor 41 executes settlement of the payment of the settlement amount. When the processor 41 executes settlement by a credit card, the processor 41 accesses the settlement server 50, thereby executing the settlement by the credit card which the settler presents. Incidentally, the settlement of the settlement amount may be settlement in cash or by electronic money, may be settlement by a prepaid card, or may be settlement by direct debit from a bank account.

If the settlement is normally completed (ACT 55, YES), the processor 41 notifies the settler of the completion of settlement (ACT 56), and terminates the series of checkout processes. For example, the processor 41 causes the display 22 to display a notification of the normal completion of settlement, and terminates the process.

In addition, if the personal authentication is incomplete (ACT 52, NO), the processor 41 issues a notification that the settlement is incomplete or the personal authentication is erroneous (ACT 57), and terminates the series of checkout processes. Furthermore, if the settlement was impossible (ACT 55, NO), the processor 41 issues a notification that the settlement is impossible (ACT 57), and terminates the series of checkout processes.

Incidentally, the above-described settlement process is merely an example, and the settlement process may be any process if the settlement process can settle the payment of commodity prices, based on the commodity price list obtained as a result of the commodity detection process. For example, the settlement method of the settlement amount based on the commodity price list is not limited to the above method.

Next, the data edit process in the settlement apparatus 1A is described.

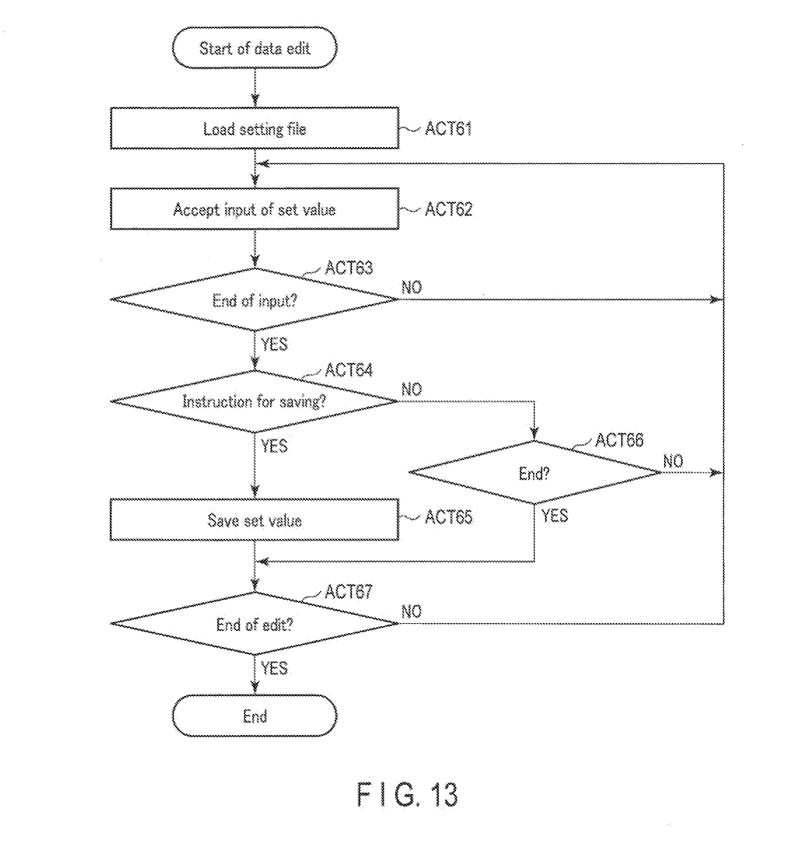

FIG. 13 is a flowchart for describing the data edit process in the settlement apparatus 1A.

In a standby state, the processor 41 accepts a request for starting data edit. For example, when the keyboard was connected to the I/F 47e, the processor 41 sets a data edit mode as the operation mode, and starts the data edit process. In the data edit process, the processor 41 acquires a setting file as a threshold database from the HDD 44 (ACT 61).

Upon acquiring the setting file, the processor 41 causes the display 22 to display various setting items and setting values (thresholds) stored in the setting file, and accepts an input of an alteration of setting values (ACT 62). For example, the operator moves the cursor to a set value of an item that is to be altered, by arrow keys of the keyboard, and inputs a desired value (change value). After completing the input of all change values, the operator presses an input end key (e.g. ESC key) indicating the end of input of change values, and starts a finishing work.

If the processor 41 detects the input to the input end key (ACT 63, YES), the processor 41 ends the input work, and starts the finishing work. In the finishing work, the processor 41 accepts an instruction for saving the input set values or an instruction for ending the edit without saving.

If the processor 41 detects an input to a saving instruction key (e.g. Enter key) which instructs saving (ACT 64, YES), the processor 41 overwrites the input set values (change values) on the setting file and saves the input set values (ACT 65). After ending the saving of the set values in the setting file, the processor 41 stands by for an operation of ending edit (ACT 67). For example, as the operation for ending edit, the processor 41 waits for detachment of the keyboard from the I/F 47e. Upon accepting the operation for ending edit (ACT 67, YES), the processor 41 terminates the data edit process.

In addition, if the processor 41 detects an input to an end instruction key (e.g. Q key) for terminating the edit without saving (ACT 66, YES), the processor 41 does not save the change values, and stands by for an operation of ending data edit (ACT 67). Upon accepting the operation of ending data edit (ACT 67, YES), the processor 41 terminates the data edit process.

Besides, if a key, other than the saving instruction key and end instruction key, is input in the finishing work (ACT 66, NO), the processor 41 returns to ACT 62. Thereby, the processor 41 suspends the finishing work, and accepts an input of an alteration of a set value.

As described above, after executing the authentication of the settler by the first personal authentication, if the commodities that are objects of settlement meet a predetermined condition, the settlement apparatus according to the first embodiment further executes the authentication of the settler by the second personal authentication of the factor that is different from the factor of the first personal authentication. Thereby, the settlement apparatus according to the first embodiment can execute appropriate personal authentication corresponding to the predetermined condition for the commodities that are objects of settlement. As a result, the settlement apparatus according to the first embodiment can realize balanced adjustment between the reduction in time of checkout and the minimization of the error in personal authentication.

In addition, after executing the authentication of the settler by the facial authentication as the first personal authentication, if the commodities that are objects of settlement meet a predetermined condition, the settlement apparatus according to the first embodiment further executes the authentication of the settler by the second personal authentication by the factor other than biometric characteristic. Thereby, the settlement apparatus according to the first embodiment can simply execute personal authentication by the facial authentication if the commodities do not meet the predetermined condition, and can execute personal authentication by not only the facial authentication but also authentication other than biometrics authentication, if the commodities meet the predetermined condition.

In addition, the settlement apparatus according to the first embodiment can set, as the above predetermined condition, a condition that the total price amount of commodities that are the objects of settlement is a set price amount or more. In this case, if the settlement amount is less than the set price amount, the settlement apparatus according to the first embodiment can execute simple personal authentication by the first personal authentication. If the settlement amount is the set price amount or more, the settlement apparatus can execute strict personal authentication by the first personal authentication and second personal authentication with different factors.

Moreover, the settlement apparatus according to the first embodiment can set, as the above predetermined condition, a condition that the number of commodities that are the objects of settlement is a set number or more. In this case, if the number of commodities that are the objects of settlement is less than the set number, the settlement apparatus according to the first embodiment can execute simple personal authentication by the first personal authentication. If the number of commodities that are the objects of settlement is the set number or more, the settlement apparatus can execute strict personal authentication by the first personal authentication and second personal authentication with different factors.

Besides, the settlement apparatus according to the first embodiment can set, as the above predetermined condition, a condition that a preset specific commodity exists among commodities that are the objects of settlement. In this case, if no preset specific commodity exists among commodities that are the objects of settlement, the settlement apparatus according to the first embodiment can execute simple personal authentication by the first personal authentication. If a preset specific commodity exists among commodities that are the objects of settlement, the settlement apparatus can execute strict personal authentication by the first personal authentication and second personal authentication with different factors.

### Second Embodiment

A settlement apparatus according to a second embodiment will be described hereinafter.

In the second embodiment, an operational mode is assumed in which an RFID that stores information including commodity identification information is added to each commodity. Each commodity may be any commodity if the commodity is handled as one piece with each RFID at a time of settlement. For example, the RFID is attached to the package of the commodity, or attached directly to the commodity. In addition, the RFID may be added to the commodity as a tag, or may be added to a case or a hanger for setting the commodity.

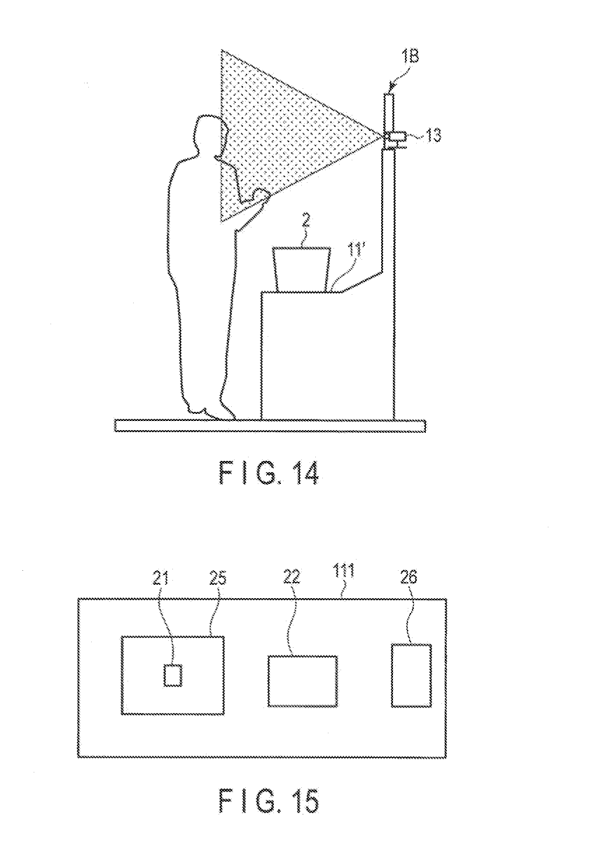

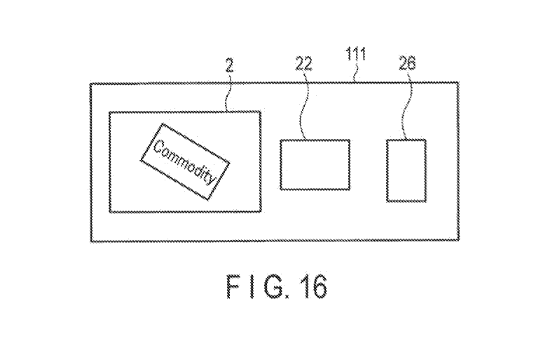

FIG. 14 is a schematic view illustrating an external-appearance configuration example of a settlement apparatus 1B according to the second embodiment. FIG. 15 and FIG. 16 are views illustrating configuration examples of a top side of a table 11′ of the settlement apparatus 1B.

The settlement apparatus 1B, like the settlement apparatus 1A, recognizes commodities which are objects of settlement, and settles the payment of the purchase price of the recognized commodities. The settlement apparatus 1B, however, may be installed, for example, in a store as a self-checkout system, or may be an ordinary cash register which a salesclerk of the store operates.

As illustrated in FIG. 14, the settlement apparatus 1B includes a table 11′, and a camera 13. The settlement apparatus 1B settles for commodities in a basket 2 placed on the table 11′, as commodities that are objects of settlement. The settlement apparatus 1B may be configured to settle for commodities which are directly disposed on the table 11′. The settlement apparatus 1B recognizes the respective commodities by reading RFIDs, which are added to the commodities, in the communication range of the process on the table 11′.

The camera 13, like the second camera 13 of the settlement apparatus 1A, is a camera for photographing the face of a user (“settler”) who executes settlement. The camera 13 captures a face image including the face as first biometric characteristic. It should suffice if the camera 13 acquires the first biometric characteristic corresponding to first personal authentication.

In addition, as illustrated in FIG. 15 and FIG. 16, in the settlement apparatus 1B, a basket sensor 21, a display 22, an RFID reader 25 and a fingerprint scanner 26 are provided on the table 11′.

The basket sensor 21 detects the basket 2. The basket sensor 21 is provided at a position on the table 11′, where the basket 2 is placed. The basket sensor 21 detects the basket 2 which is placed on the table 11′, as illustrated in FIG. 16.

The display 22 displays guidance, etc. to the user. The display 22 is disposed on the table 11′. The position of disposition of the display 22 is not limited to a specific position. The display 22 may be a display device with a touch panel.

The RFID reader 25 reads an RFID which is added to the commodity. The RFID reader 25 communicates with an RFID existing in the communication range on the table 11′. The RFID reader 25 reads information, such as commodity identification information, from each RFID within the communication range. The RFID reader 25 is set such that the communication range of the RFID reader 25 is at least the inside of the basket 2 which the basket sensor 21 detects. Incidentally, in an operation mode in which commodities are directly placed on the table 11′, the RFID reader 25 is configured such that the communication range thereof includes a region where the commodities that are objects of settlement are disposed.

The fingerprint scanner 26 reads a fingerprint as second biometric characteristic. The fingerprint scanner 26 reads the fingerprint of the settler, in order to execute fingerprint authentication as second personal authentication. The fingerprint scanner 26 acquires the second biometric characteristic for the second personal authentication.

Next, a configuration example of a control system of the settlement apparatus 1B is described.

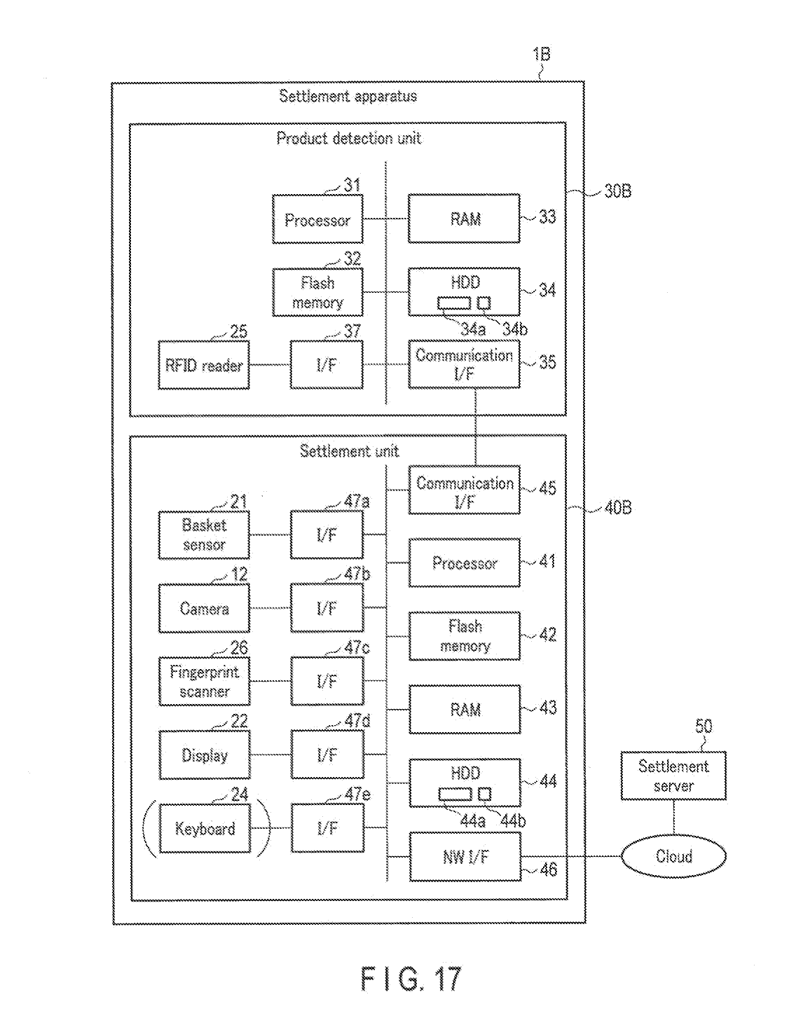

FIG. 17 is a block diagram illustrating a configuration example of the control system of the settlement apparatus 1B.

In the configuration example illustrated in FIG. 17, the settlement apparatus 1B includes a commodity detection unit 30B and a settlement unit 40B. The commodity detection unit 30B executes a commodity detection process of detecting commodities that are objects of settlement. The settlement unit 40B executes a settlement process of the commodities which the commodity detection unit 30B detected. For example, the commodity detection unit 30B detects commodities, and creates a list (commodity price list) 34b which associates the detected commodities and the prices of the respective commodities. The settlement unit 40B executes settlement on the commodity price list 34b which the commodity detection unit 30B created.

In the configuration example illustrated in FIG. 17, the commodity detection unit 30B includes a processor 31, a flash memory 32, a RAM 33, an HDD 34, a communication I/F 35, and an I/F 37. The processor 31, flash memory 32, RAM 33, HDD 34, communication I/F 35 and I/F 37 are connected via a bus.

Incidentally, in the commodity detection unit 30B illustrated in FIG. 17, the same hardware as in the commodity detection unit 30A illustrated in FIG. 4 is denoted by like reference numerals, and a detailed description thereof is omitted.

In the commodity detection unit 30B, the processor 31 executes the commodity detection process of detecting (recognizing) commodities by information which is read from the RFIDs that are added to the commodities. The commodity detection unit 30B stores, in the flash memory 32 or HDD 34, a program for detecting (recognizing) commodities by information which is read from the RFIDs that are added to the commodities. The processor 31 realizes the commodity detection process, based on the program which the flash memory 32 or HDD 34 stores.

The I/F 37 is an interface for connection to the RFID reader 25. The I/F 37 functions as an information acquisition unit which acquires commodity identification information (commodity ID) which the RFID reader 25 read from the RFIDs that are added to the commodities. The processor 31 recognizes the prices of commodities of the commodity identification information which was read from the RFIDs, by referring to the commodity DB 34a.

In the configuration example illustrated in FIG. 17, the settlement unit 40B includes a processor 41, a flash memory 42, a RAM 43, an HDD 44, a communication I/F 45, a network (NW) I/F 46, and a plurality of I/Fs 47 (47a, 47b, and 47d to 47f). The processor 41, flash memory 42, RAM 43, HDD 44, communication I/F 45, network (NW) I/F 46 and I/Fs 47a, 47b, and 47d to 47f are connected via a bus. Incidentally, in the settlement unit 40B illustrated in FIG. 17, the same hardware as in the settlement unit 40A illustrated in FIG. 4 is denoted by like reference numerals, and a detailed description thereof is omitted.

The processor 41 executes the settlement process of the second embodiment, by executing the programs which the flash memory 42 or HDD 44 stores. In the settlement process of the second embodiment, the processor 41 includes a function of executing personal authentication (biometrics authentication) by two kinds of biometric characteristic. In the configuration example illustrated in FIG. 17, the processor 41 executes facial authentication by the face (first biometric characteristic) as a first personal authentication, and executes fingerprint authentication by the fingerprint (second biometric characteristic) as a second personal authentication.

In the meantime, the first personal authentication is not limited to the facial authentication. The first personal authentication may be replaced with personal authentication by biometric characteristic other than the face. In addition, the second personal authentication is not limited to the fingerprint authentication. The second personal authentication may be any authentication if the second personal authentication is authentication by biometric characteristic other than the first personal information. The second personal authentication may be replaced with biometrics authentication by biometric characteristic, other than the fingerprint authentication. It should be noted, however, that the settlement unit 40B illustrated in FIG. 17 can facilitate the input of authentication information by the user, by executing facial authentication as the first personal authentication. Furthermore, the settlement unit 40B illustrated in FIG. 17 can realize reliable authentication which is less affected by an environmental change, etc. than the facial authentication, by executing fingerprint authentication as the second personal authentication.

The flash memory 42 or HDD 44 stores programs for the second settlement process using the first personal authentication and second personal authentication. In addition, the flash memory 42 or HDD 44 stores a program for executing the first personal authentication, and a program for executing the second personal authentication. Incidentally, a part of various functions which the processor 41 realizes by executing programs, as will be described later, may be realized by hardware.

The HDD 44 of the settlement unit 40B includes a personal information database DB 44a which stores personal information including dictionary data for the first personal authentication, and dictionary data for the second personal authentication. In the example illustrated in FIG. 17, the dictionary data for the first personal authentication is characteristic information (facial authentication information) of the face of a enrolled person for use in facial authentication. The dictionary data for the second personal authentication is characteristic information (fingerprint authentication information) of the face of the enrolled person for use in fingerprint authentication. Incidentally, the fingerprint authentication information is characteristic points of fingerprints, which are extracted from images of fingerprints, and information on relations.

The I/F 47f is an interface for connection to the fingerprint scanner 26. The I/F 47f functions as an image acquisition unit which acquires an image (fingerprint image) including a fingerprint which the fingerprint scanner 26 scans. For example, the processor 41 instructs, via the I/F 47f, the fingerprint scanner 26 to scan a fingerprint image, and acquires the fingerprint image which the fingerprint scanner 26 read. The fingerprint scanner 26 may include a sensor which detects that a finger (fingerprint) was placed over the region that is scanned. When the sensor detected that the fingerprint was placed over the region that is scanned, the fingerprint sensor 26 may start the scan of the fingerprint image.

Next, a description is given of a checkout process in the settlement apparatus 1B according to the second embodiment.

The settlement apparatus 1B executes the checkout process in the same flow as in the process illustrated in FIG. 9. The settlement apparatus 1B differs from the settlement apparatus 1A with respect to the commodity detection process and the personal authentication process. Thus, as regards the checkout process in the settlement apparatus 1B, a description is given of the commodity detection process and the personal authentication process.

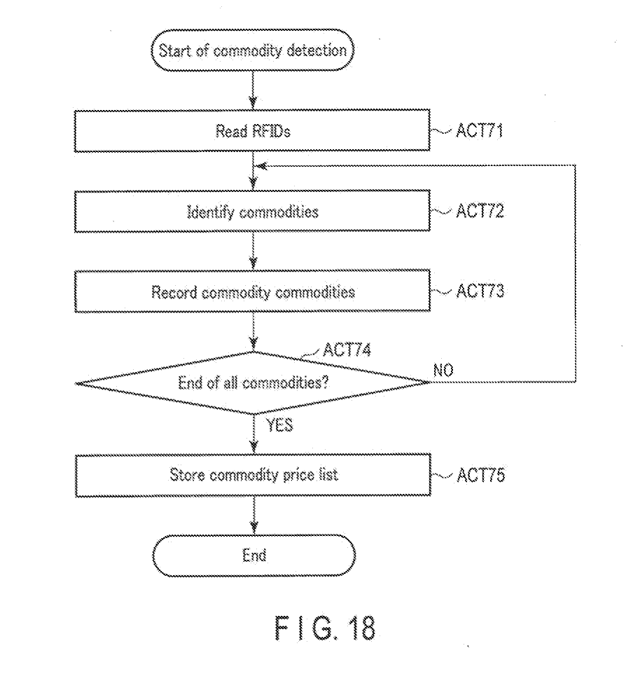

FIG. 18 is a flowchart for describing the commodity detection process in the settlement apparatus 1B.

Responding to the request for starting the commodity detection process from the settlement unit 40B, the processor 31 of the commodity detection unit 30B starts the commodity detection process. To start with, the processor 31 reads, by the RFID reader 25, RFIDs which are added to commodities on the table 11′ (ACT 71). The processor 31 instructs the RFID reader 25 to read the RFIDs via the I/F 37. In accordance with the instruction from the processor 31, the RFID reader 25 reads information stored in the RFIDs which exist within a predetermined communication range. The communication range is set to be a range including at least the inside of the basket 2 placed on the table 11′. The RFID reader 25 outputs the information, which was read from each RFID within the communication range, to the processor 31 via the I/F 37. The processor 31 acquires, via the I/F 37, the information which the RFID reader 25 read from each RFID. The processor 31 temporarily stores in the RAM 33 the information which the RFID reader 25 read from each RFID.

Upon storing the information read from each RFID within the communication range, the processor 31 identifies each commodity, based on the information read from each RFID (ACT 72). For example, the processor 31 identifies commodities (commodity information of the commodity DB 34a) by commodity IDs included in the information read from the RFIDs.

Upon identifying the commodities, the processor 31 additionally writes the information including the prices of the commodities to the commodity price list created on the RAM 33, based on the commodity information of the identified commodities (ACT 73). The processor 31 determines whether the detection (recognition) of the commodities corresponding to all RFIDs that the RFID reader 25 read was completed (ACT 74). If the processor 31 determines that the detection of the commodities corresponding to all read RFIDs is incomplete (ACT 74, NO), the processor 31 repeatedly executes the process of ACT 72 and ACT 73. If the processor 31 determines that the detection of the commodities corresponding to all read RFIDs is completed (ACT 74, YES), the processor 31 stores the created commodity price list 34b in the HDD 34 (ACT 75). Upon storing the commodity price list 34b in the HDD 34, the processor 31 notifies the processor 41 of the settlement unit 40B of the end of the commodity detection process.

Incidentally, the above-described commodity detection process is merely an example of the commodity detection process which can be provided to the settlement apparatus 1B. Like the settlement apparatus 1A, the commodity detection process in the settlement apparatus 1B may be any process if a commodity registration list can be obtained as a result of the commodity detection process. For example, like the settlement apparatus 1A, the settlement apparatus 1B may be configured to detect commodities by bar code recognition. In addition, the commodity detection process of the settlement apparatus 1B may be pattern recognition, object recognition, or OCR.

Next, the personal authentication process in the settlement apparatus 1B is described.

FIG. 19 is a flowchart for describing the flow of the personal authentication process in the settlement apparatus 1B.

Upon starting the personal authentication process, the processor 41 of the settlement apparatus 1B captures, by the camera 13, an image including the face of the user (ACT 81). The processor 41 instructs, via the I/F 47b, the camera 13 to start photography. The processor 41 acquires, via the I/F 47b, the photographed image which the camera 13 captured. Upon acquiring the photographed image of the camera 13, the processor 41 temporarily stores the photographed image in the RAM 43.

Upon storing the photographed image of the camera 13, the processor 41 detects a face region of the person in the photographed image (ACT 82). Upon detecting the face region, the processor 41 detects characteristic information (landmark) of the face from the image of the detected face region as first biometric characteristic (ACT 83). The processor 41 temporarily stores information indicative of the detected characteristic information of the face in the RAM 43. For example, the processor 41 detects, as a landmark, a predetermined part such as the outer corner of the eye, the inner corner of the eye, the nose, the mouth, etc. The processor 41 temporarily stores in the RAM 43 information (landmark information) indicative of a relative position of the detected landmark. Incidentally, the processor 41 may, if within a predetermined time, repeat photography of images by the camera 13 until successfully detecting the characteristic information of the face from the photographed image.

Upon storing the characteristic information of the face as the first biometric characteristic, the processor 41 determines the similarity score by collating the information (first biometric characteristic) detected from the photographed image and the characteristic information (dictionary data) of the enrolled person who is already enrolled in the personal information DB (ACT 84). For example, the processor 41 determines the similarity score (the similarity score of the face) between the characteristic information (landmark) of the face, which was detected from the photographed image, and the characteristic information (landmark) of the face as the facial authentication information of each enrolled person in the personal information DB 44a.

Upon determining the similarity score of the face to each enrolled person, the processor 41 determines whether the highest similarity score of similarity score to each enrolled person is a threshold for facial authentication or more (ACT 85). The threshold for facial authentication is a reference value of the similarity score for determining the identity of the person in the facial authentication. When the similarity score is the threshold for facial authentication or more, the processor 41 determines the identity of the person in the facial authentication as the first personal authentication. Incidentally, it is assumed that the threshold for facial authentication is settable by the data edit process.

If the processor 41 determines that the highest similarity score is not the threshold for facial authentication or more (ACT 85, NO), the processor 41 determines that the personal authentication by facial authentication failed (ACT 93). Upon determining that the personal authentication failed, the processor 41 stores in the HDD 34 an authentication result indicating that the personal authentication failed (ACT 94).

If the processor 41 determines that the highest similarity score is the threshold for facial authentication or more (ACT 85, YES), the processor 41 acquires the commodity price list 34b that was obtained by the commodity detection process (ACT 86). For example, the processor 41 acquires the commodity price list 34b from the HDD 34 of the commodity detection unit 30A. In the meantime, in the case of executing the personal authentication process and commodity detection process in parallel, the processor 41 executes the process of ACT 85 after the end of the commodity detection process.

Upon acquiring the commodity price list 34b, the processor 41 determines whether personal authentication of a second stage (second personal authentication) is necessary or not (ACT 87). The settlement apparatus 1B executes fingerprint authentication as the second-stage personal authentication, if the content of commodities that are objects of settlement meets a predetermined condition after the first personal authentication was successfully carried out.

In addition, the processor 41 determines whether the second-stage personal authentication is necessary or not, according to whether a predetermined condition is satisfied or not. The condition is set for, for example, the content of commodities to be settled. For example, the second-stage personal authentication may be executed when the settlement amount (payment amount) is a threshold or more, like the first condition shown in FIG. 8. In addition, the second-stage personal authentication may be executed when the number of commodities to be settled is a preset number or more, like the second condition shown in FIG. 8. Besides, the second-stage personal authentication may be executed when a specific commodity is included in the commodities to be settled. Furthermore, the second-stage personal authentication may be executed when a combination of a plurality of conditions is met.

Here, it is assumed that the second-stage personal authentication is executed when the number of commodities to be settled exceeds a preset number (when the second condition is satisfied). When the second condition is set, the processor 41 determines whether the number of commodities in the commodity price list is a preset number or more (ACT 87). If the processor 41 determines that the number of commodities in the commodity price list is not the preset number or more (ACT 87, NO), the processor 41 determines that the personal authentication was completed (ACT 92). Upon determining that the personal authentication was completed, the processor 41 stores a personal authentication result indicating that the personal authentication was completed (ACT 94).

In addition, if the processor 41 determines that the number of commodities is the preset number or more (ACT 87, YES), the processor 41 executes fingerprint authentication by a fingerprint (second biometric characteristic) as the second-stage personal authentication. The processor 41 causes the display 22 to display input guidance of the fingerprint. For example, the processor 41 causes the display 22 to display such guidance that the fingerprint authentication is necessary, and prompts the settler to place a finger over the fingerprint scanner 26.

After displaying the fingerprint input guidance on the display 22, the processor 41 reads the fingerprint by the fingerprint scanner 26 (ACT 89). The processor 41 collates the fingerprint, which the fingerprint scanner 26 read, and the fingerprint authentication information of the enrolled person identified by the facial authentication in the personal information DB 44a (ACT 90). The processor 41 determines the similarity score of fingerprints, as a authentication result between the read fingerprint and the fingerprint authentication information of the enrolled person. Upon determining the similarity score of fingerprints, the processor 41 determines whether the similarity score of fingerprints is a threshold for fingerprint authentication or more (ACT 91).

For example, the processor 41 photographs, by the fingerprint scanner 26, the finger which was placed over the fingerprint scanner 26, and extracts characteristic points of the fingerprint in the photographed image, and information on relations. The processor 41 temporarily stores in the RAM 43, as input fingerprint information, the characteristic points of the fingerprint extracted from the photographed image, and the information on relations. The processor 41 calculates the similarity score between the temporarily stored input fingerprint information and the fingerprint authentication information (fingerprint characteristics and information on relations) of the enrolled person enrolled in the personal information DB 44a. The processor 41 determines whether the calculated similarity score of fingerprints is a threshold for fingerprint authentication or more, which is set in the setting file 44b.

If the processor 41 determines that the similarity score of fingerprints is the threshold or more (ACT 91, YES), the processor 41 determines that the personal authentication is completed (ACT 92). Upon determining that the personal authentication is completed, the processor 41 stores a personal authentication result indicating the completion of the personal authentication (ACT 94).

In addition, if the processor 41 determines that the similarity score of fingerprints is not the threshold or more (ACT 91, NO), the processor 41 determines that the personal authentication is incomplete (failed) (ACT 93). Upon determining that the personal authentication failed, the processor 41 stores a personal authentication result indicating the incompletion of the personal authentication (ACT 94).

Incidentally, the personal authentication process in the settlement apparatus 1B is not limited to the above-described example. The personal authentication process in the settlement apparatus 1B may be any process if the personal authentication process executes the second-stage personal authentication when the predetermined condition was satisfied after the first personal authentication was successfully carried out. The second-stage personal authentication is personal authentication by biometric characteristic different from the biometric characteristic of the first personal authentication. For example, when the first personal authentication is facial authentication, the second-stage personal authentication is authentication by biometric characteristic other than the face, such as a fingerprint, iris, vein pattern, or voiceprint.

As described above, after executing the authentication of the settler by the biometrics authentication by the first biometric characteristic as the first personal authentication, if the commodities that are objects of settlement meet a predetermined condition, the settlement apparatus according to the second embodiment further executes the biometrics authentication by the second biometric characteristic as the second personal authentication. Thereby, the settlement apparatus according to the second embodiment can execute a plurality of stages of biometrics authentication in accordance with the predetermined condition for the commodities that are objects of settlement. As a result, the settlement apparatus according to the second embodiment can realize balanced adjustment between the reduction in time of checkout and the minimization of the error in biometrics authentication.

In addition, after executing the authentication of the settler by the biometrics authentication by the face as the first biometric characteristic, if the commodities that are objects of settlement meet a predetermined condition, the settlement apparatus according to the second embodiment executes the biometrics authentication by the biometric characteristic (fingerprint) other than the face as the second biometric characteristic. Thereby, the settlement apparatus according to the second embodiment can simply execute personal authentication by the facial authentication if the commodities do not meet the predetermined condition, and can execute personal authentication by not only the facial authentication but also other biometrics authentication, if the commodities meet the predetermined condition.

In addition, the settlement apparatus according to the second embodiment can set, as the above predetermined condition, a condition that the total price amount of commodities that are the objects of settlement is a set price amount or more. In this case, if the settlement amount is less than the set price amount, the settlement apparatus according to the second embodiment can execute simple personal authentication by the first personal authentication. If the settlement amount is the set price amount or more, the settlement apparatus can execute strict personal authentication by not only the first personal authentication but also the second-stage personal authentication.

Moreover, the settlement apparatus according to the second embodiment can set, as the above predetermined condition, a condition that the number of commodities that are the objects of settlement is a set number or more. In this case, if the number of commodities that are the objects of settlement is less than the set number, the settlement apparatus according to the second embodiment can execute simple personal authentication by the first personal authentication. If the number of commodities that are the objects of settlement is the set number or more, the settlement apparatus can execute strict personal authentication by not only the first personal authentication but also the second-stage personal authentication.

Besides, the settlement apparatus according to the second embodiment can set, as the above predetermined condition, a condition that a preset specific commodity exists among commodities that are the objects of settlement. In this case, if no preset specific commodity exists among commodities that are the objects of settlement, the settlement apparatus according to the second embodiment can execute simple personal authentication by the first personal authentication. If a preset specific commodity exists among commodities that are the objects of settlement, the settlement apparatus can execute strict personal authentication by not only the first personal authentication but also the second-stage personal authentication.

### Third Embodiment

A settlement apparatus according to a third embodiment will be described hereinafter.

A settlement apparatus 1C according to the third embodiment can be realized by the same hardware configuration as in the settlement apparatus 1A illustrated in FIG. 1 to FIG. 4, which was described in the first embodiment. Thus, a detailed description of the hardware configuration of the settlement apparatus 1C is omitted. However, in the settlement apparatus 1C, the input keys in the configuration example illustrated in FIG. 2 to FIG. 4 may be omitted.

Next, a description is given of a checkout process in the settlement apparatus 1C according to the third embodiment.

The settlement apparatus 1C executes the checkout process in the same flow as in the process illustrated in FIG. 9. The settlement apparatus 1C differs from the settlement apparatus 1A with respect to the personal authentication process. Thus, as regards the checkout process in the settlement apparatus 1C, a description is given of the personal authentication process.

FIG. 20 is a flowchart for describing the flow of the personal authentication process in the settlement apparatus 1C.

Upon starting the personal authentication process, the processor 41 of the settlement apparatus 1C captures, by the second camera 13, an image including the face of the user (ACT 101). The processor 41 temporarily stores the photographed image of the second camera 13 in the RAM 43, and detects a face region of the person in the photographed image (ACT 102). Upon detecting the face region, the processor 41 detects characteristic information (landmark) of the face from the image of the detected face region (ACT 103). The processor 41 temporarily stores information indicative of the detected characteristic point of the face in the RAM 43. The processor 41 determines the similarity score of the face to each enrolled person, by collating the characteristic information of the face detected from the photographed image and the facial authentication information of each enrolled person in the personal information DB 44a (ACT 104).

Upon determining the similarity score of the face to each enrolled person, the processor 41 determines whether the highest similarity score of similarity score to each enrolled person is a first threshold for facial authentication or more (ACT 105). The first threshold for facial authentication is, for example, set information which is stored in the setting file 44b. If the processor 41 determines that the highest similarity score is not the first threshold for facial authentication or more (ACT 105, NO), the processor 41 determines that the personal authentication failed (ACT 110). Upon determining that the personal authentication failed, the processor 41 stores in the HDD 34 an authentication result indicating that the personal authentication failed (ACT 111).

If the processor 41 determines that the highest similarity score is the first threshold for facial authentication or more (ACT 105, YES), the processor 41 acquires the commodity price list 34b that was obtained by the commodity detection process (ACT 106). For example, the processor 41 acquires the commodity price list 34b from the HDD 34 of the commodity detection unit 30A. In the meantime, in the case of executing the personal authentication process and commodity detection process in parallel, the processor 41 executes the process of ACT 106 after the end of the commodity detection process.

Upon acquiring the commodity price list 34b, the processor 41 determines whether facial authentication by a second threshold (second personal authentication) is necessary or not, based on the information of the commodity price list 34b (ACT 107). The second threshold is a value which is higher than at least the first threshold. The settlement apparatus 1C executes the authentication by the second threshold, if the content of commodities that are objects of settlement meets a predetermined condition after the authentication by the first threshold was successfully carried out.

In addition, the processor 41 determines whether the authentication by the second threshold is necessary or not, according to whether a predetermined condition is satisfied or not. The condition is set for, for example, the content of commodities to be settled. For example, the authentication by the second threshold may be executed when the settlement amount (payment amount) is a threshold or more, like the first condition shown in FIG. 8. In addition, the personal authentication by the second threshold may be executed when the number of commodities to be settled is a preset number or more, like the second condition shown in FIG. 8. Besides, the personal authentication by the second threshold may be executed when a specific commodity is included in the commodities to be settled. Furthermore, the personal authentication by the second threshold may be executed when a combination of a plurality of conditions is met.

Here, it is assumed that the personal authentication by the second threshold is executed when a specific commodity is included in the commodities to be settled. The processor 41 determines whether a specific commodity exists in the commodities registered in the commodity price list 34b (ACT 107). If the processor 41 determines that there is no specific commodity (ACT 107, NO), the processor 41 determines that the personal authentication was completed (ACT 109). Upon determining that the personal authentication was completed, the processor 41 stores a personal authentication result indicating that the personal authentication was completed (ACT 111).

In addition, if the processor 41 determines that there is a specific commodity (ACT 107, YES), the processor 41 determines whether the highest similarity score is the second threshold for facial authentication or more (ACT 108). The second threshold is set information stored in the setting file 44b. The second threshold is a value which is higher than at least the first threshold.

If the processor 41 determines that the highest similarity score is the second threshold or more (ACT 108, YES), the processor 41 determines that the personal authentication is completed (ACT 109). Upon determining that the personal authentication is completed, the processor 41 stores a personal authentication result indicating the completion of the personal authentication (ACT 111).

In addition, if the processor 41 determines that the highest similarity score is not the second threshold or more (ACT 108, NO), the processor 41 determines that the personal authentication is incomplete (failed) (ACT 110). Upon determining that the personal authentication failed, the processor 41 stores a personal authentication result indicating the incompletion of the personal authentication (ACT 111).

Incidentally, the personal authentication process in the settlement apparatus 1C is not limited to the above-described example. The personal authentication process in the settlement apparatus 1C may be any process if the personal authentication process executes the authentication by the second threshold, which is higher than the first threshold, when the predetermined condition was satisfied after the authentication by the first threshold was successfully carried out. For example, in the settlement apparatus 1C, the personal authentication by the first threshold and second threshold is the facial authentication. The personal authentication by the first threshold and second threshold may be authentication by biometric characteristic other than the face, such as a fingerprint, iris, vein pattern, or voiceprint.

As described above, the settlement apparatus according to the third embodiment executes the first personal authentication which determines the success in authentication if the similarity score between the information obtained from the settler and the information of the enrolled person enrolled in the database is the first threshold or more. After executing the first personal authentication, if the commodities that are objects of settlement meet a predetermined condition, the settlement apparatus according to the third embodiment executes the second personal authentication which determines the success in authentication if the similarity score is the second threshold or more, the second threshold being higher than the first threshold. Thereby, the settlement apparatus according to the third embodiment can execute appropriate personal authentication corresponding to the predetermined condition for the commodities that are objects of settlement. As a result, the settlement apparatus according to the third embodiment can realize balanced adjustment between the reduction in time of checkout and the minimization of the error in personal authentication.

For example, after executing the first personal authentication which determines the success in authentication if the similarity score between the face of the settler and the facial authentication information that the database stores is the first threshold or more, if the commodities that are objects of settlement meet a predetermined condition, the settlement apparatus according to the third embodiment executes the second personal authentication which determines the success in authentication if the similarity score is the second threshold or more, the second threshold being higher than the first threshold. Thereby, the settlement apparatus according to the third embodiment can simply execute personal authentication by the first threshold if the commodities do not meet the predetermined condition, and can execute strict personal authentication by the second threshold that is higher than the first threshold, if the commodities meet the predetermined condition.

In addition, the settlement apparatus according to the third embodiment can set, as the above predetermined condition, a condition that the total price amount of commodities that are the objects of settlement is a set price amount or more. In this case, if the settlement amount is less than the set price amount, the settlement apparatus according to the third embodiment can execute simple biometrics authentication by the first threshold. If the settlement amount is the set price amount or more, the settlement apparatus can execute strict biometrics authentication by the second threshold.

Moreover, the settlement apparatus according to the third embodiment can set, as the above predetermined condition, a condition that the number of commodities that are the objects of settlement is a set number or more. In this case, if the number of commodities that are the objects of settlement is less than the set number, the settlement apparatus according to the third embodiment can execute simple biometrics authentication by the first threshold. If the number of commodities that are the objects of settlement is the set number or more, the settlement apparatus can execute strict biometrics authentication by the second threshold.

Besides, the settlement apparatus according to the third embodiment can set, as the above predetermined condition, a condition that a preset specific commodity exists among commodities that are the objects of settlement. In this case, if no preset specific commodity exists among commodities that are the objects of settlement, the settlement apparatus according to the third embodiment can execute simple personal authentication by the first threshold. If a preset specific commodity exists among commodities that are the objects of settlement, the settlement apparatus can execute strict biometrics authentication by the second threshold.

In each of the above-described embodiments, the case was described in which the programs that the processor executes are prestored in the memory in the apparatus. However, the programs which the processor executes can be downloaded in the apparatus through a network, or can be installed in the apparatus from a computer-readable storage medium. The form of the computer-readable storage medium can be any form, such as a CD-ROM, as long as the computer-readable storage medium can store programs and is readable by the apparatus. In addition, the functions obtained by installation or download in advance can be realized in cooperation with an OS (Operating System) or the like in the apparatus.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A settlement apparatus comprising:
a commodity detection unit configured to detect commodities to be settled;
a personal authentication unit configured to execute first personal authentication on a settler who settles a purchase price of the commodities which the commodity detection unit detects, and to further execute second personal authentication if the commodities which the commodity detection unit detects meet a predetermined condition; and
a settlement unit configured to settle the purchase price of the commodities which the commodity detection unit detected, if the personal authentication by the personal authentication unit was successfully carried out.

2. The apparatus of claim 1, wherein the second personal authentication is authentication by a factor different from a factor of the first personal authentication.

3. The apparatus of claim 2, wherein the first personal authentication is facial authentication, and the second personal authentication is authentication using a factor different from biometric characteristic.

4. The apparatus of claim 1, wherein the first personal authentication is biometrics authentication by first biometric characteristic, and the second personal authentication is biometrics authentication by second biometric characteristic which is different from the first biometric characteristic.

5. The apparatus of claim 4, wherein the first personal authentication is facial authentication, and the second personal authentication is biometrics authentication other than the facial authentication.

6. The apparatus of claim 1, wherein the first personal authentication is personal authentication which determines a success in authentication if a similarity score between biometric characteristic obtained from the settler and biometric characteristic of a enrolled person which a database stores is a first threshold or more, and the second personal authentication is personal authentication which determines a success in authentication if a similarity score is a second threshold or more, the second threshold being higher than the first threshold.

7. The apparatus of claim 6, wherein the first personal authentication is facial authentication which determines a success in authentication if a similarity score between a face of the settler and facial authentication information of the enrolled person which the database stores is a first threshold or more, and the second personal authentication is facial authentication which determines a success in authentication if the similarity score is a second threshold or more, the second threshold being higher than the first threshold.

8. The apparatus of claim 1, wherein the personal authentication unit is configured to execute the second personal authentication if a total price amount of all commodities which the commodity detection unit detects is a set value or more.

9. The apparatus of claim 1, wherein the personal authentication unit is configured to execute the second personal authentication if a number of commodities which the commodity detection unit detects is a set number or more.

10. The apparatus of claim 1, wherein the personal authentication unit is configured to execute the second personal authentication if a preset specific commodity exists in the commodities which the commodity detection unit detects.
